(19) United States
(12) Patent Application Publication
(10) Pub. No.: US 2008/0231933 A1
(43) Pub. Date: Sep. 25, 2008

(54) OPTICAL MODULATOR

(75) Inventor: Christopher DOERR, MIDDLETOWN, NJ (US)

Correspondence Address: BROSEMER, KOLEFAS & ASSOCIATES, LLC - (LUCENT), 1 BETHANY ROAD, BUILDING 4 - SUITE # 58, HAZLET, NJ, 07730, US

(73) Assignee: LUCENT TECHNOLOGIES INC., MURRAY HILL, NJ (US)

(21) Appl. No.: 11/690,820

(22) Filed: Mar. 24, 2007

(51) Int. Cl. G02F 1/03

(52) U.S. Cl. 359/245

(57) ABSTRACT

A driving circuit and Mach-Zehnder EAM optical modulator exhibiting negligible chirp that generates a PSK signal when driven by a single drive signal. Two such Mach-Zehnder EAM optical modulators and drive circuits may be configured in parallel, thereby generating DQPSK signals with only two drive signals, one for each individual Mach-Zehnder EAM modulator.

### FIELD OF THE INVENTION

This invention relates generally to the field of optical communications and in particular to a chirp-free optical modulator employing electro-absorption modulators (EAMs) and a drive circuit thereof.

### BACKGROUND OF THE INVENTION

Optical modulators constructed from InP or other semiconductor materials may impart certain phase changes or “chirp” to optical signals upon which they operate. Unfortunately, chirping degrades certain transmission qualities of modulated light.

Recently, optical modulators employing electro-absorption in an interferometric structure have been described for the generation of PSK, DPSK and QPSK signaling formats. (See, e.g., I. Kang, “Phase-shift-keying and on-off-keying with improved performances using electroabsorption modulators with interferometric effects,” OPTICS EXPRESS, Vol. 15, No. 4, 19 Feb. 2007). Such structures may advantageously exhibit more favorable chirp characteristics.

### SUMMARY OF THE INVENTION

According to the present invention an EAM-based optical modulator is driven in a push-pull configuration which advantageously produces an output signal having negligible chirp, thereby eliminating a significant disadvantage associated with EAMs.

Viewed from a first aspect, the present invention is directed to a driving circuit for an optical modulator constructed according to the present invention wherein the driving circuit advantageously requires only a single driving signal.

Viewed from a second aspect, the present invention is directed to a phase-shift keying optical modulator driven by a single-ended driving circuit wherein the modulator constructed from a Mach-Zehnder interferometer (MZI) with an EAM in each arm. Advantageously, an optical modulator so constructed may be used to provide modulation formats such as Differential Phase Shift Keying (DPSK), duobinary, or Differential Quadrature Phase Shift Keying (DQPSK).

In sharp contrast to the prior art, these interferometric structures exhibit reduced chirp and only employ a single driving signal for the PSK arrangement, and two driving signals for the DQPSK arrangement as opposed to two driving signals and four driving signals respectively.

### BRIEF DESCRIPTION OF THE DRAWING

A more complete understanding of the present invention may be realized by reference to the accompanying drawings in which:

FIG. 1 is a schematic of a prior art Mach-Zehnder structure;

FIG. 2a is a schematic of a representative optical modulator having a Mach-Zehnder structure including an EAM;

FIG. 2b is a schematic of a prior art driving circuit for an optical modulator such as the one shown in FIG. 2a;

FIG. 3a is a schematic of a driving circuit for the representative optical modulator of FIG. 2a according to the present invention; and

FIG. 3b is another schematic of the driving circuit of FIG. 3a for the representative optical modulator of FIG. 2a according to the present invention;

FIG. 3c is a schematic of an alternative driving circuit for the representative optical modulator of FIG. 2a according to the present invention;

FIG. 3d is a schematic of another alternative driving circuit for the representative optical modulator of FIG. 2a according to the present invention; and

FIG. 4 is a schematic of a representative optical DQPSK modulator including EAMs which may advantageously be driven by the driving circuit according to the present invention.

### DETAILED DESCRIPTION

The following merely illustrates the principles of the invention. It will thus be appreciated that those skilled in the art will be able to devise various arrangements which, although not explicitly described or shown herein, embody the principles of the invention and are included within its spirit and scope.

Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

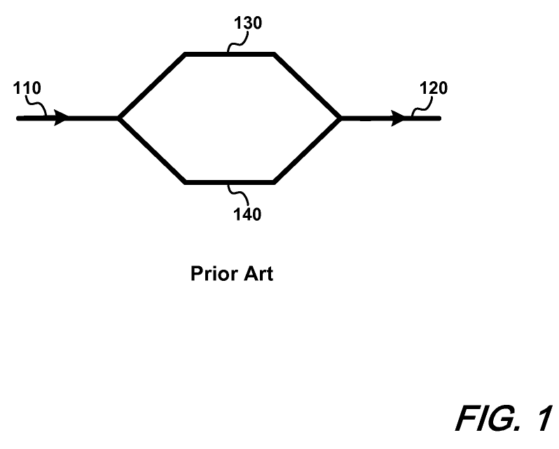

FIG. 1 shows a schematic of a prior art optical modulator apparatus which is known to those skilled in the art as a Mach-Zehnder modulator Such optical modulators are one of the key components for signal transmission systems and a number of types are known and understood. As can be appreciated, the simplicity of the Mach-Zehnder modulator contributes to its wide utilization in optical systems.

With continued reference to that FIG. 1, it may be observed that the Mach-Zehnder modulator structure includes an input waveguide 110 and an output waveguide 120, optically connected by a pair of waveguide arms 130, and 140. Accordingly, an optical signal applied to the input waveguide 110 will exit the output waveguide 120 after traversing the modulator via upper arm 130 and/or lower arm 140.

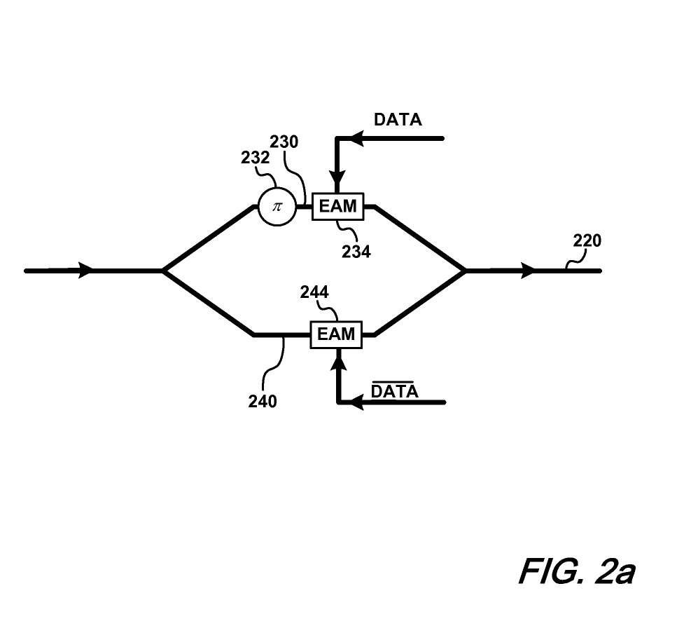

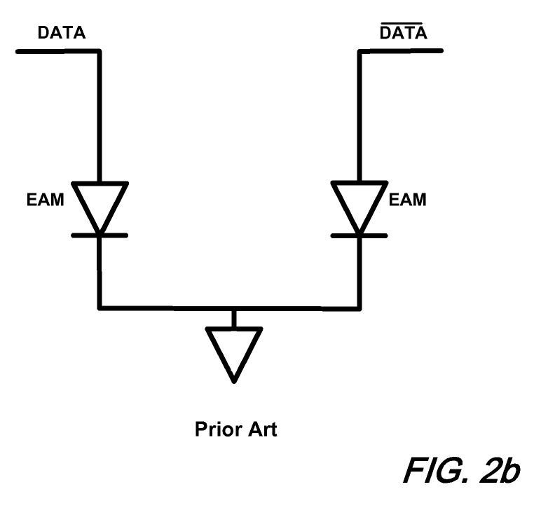

Turning now to FIG. 2a, there is shown a schematic of an optical modulator employing the Mach-Zehnder modulator structure of FIG. 1. More particularly, each of the arms 230, 240, of the Mach-Zehnder modulator include an electro-absorption modulator (EAM) 234, 244, respectively while one of the arms includes a phase shift 232. The electro-absorption modulators 234,244 absorb light traversing their respective arm according to an applied voltage to thereby generate intensity-modulated optical signals which are subsequently combined and output via output waveguide 220. Those skilled in the art will appreciate that while only one EAM positioned in one arm is sufficient to achieve phase-shift keying (PSK) modulation or on-off keying (OOK) modulation, the push-pull configuration shown in FIG. 2a is preferable as it minimizes the excess optical loss due to interference. As shown in this FIG. 2a, the EAM in the upper arm 234 is modulated by a data signal DATA while the EAM in the lower arm 244 is modulated by the complementary data signal, D̅Ā T̅Ā.

Turning now to FIG. 2b, there is shown a simple schematic of an electrical circuit for driving the push-pull operation of the device shown in FIG. 2a. As shown in this figure—two data signals are required to drive the device namely the data signal DATA and its complement D̅Ā T̅Ā.

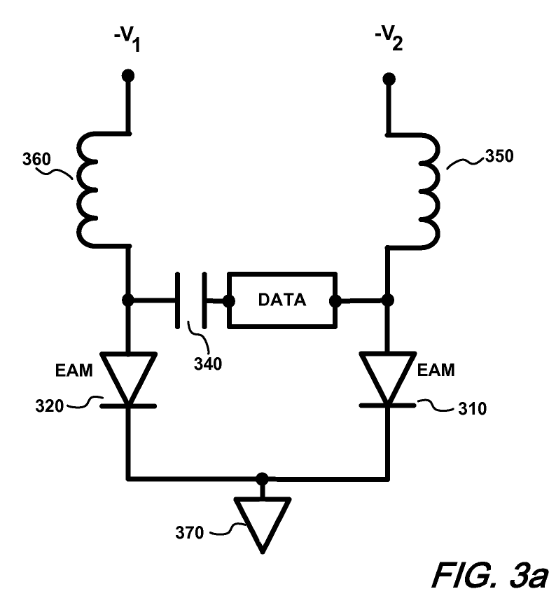

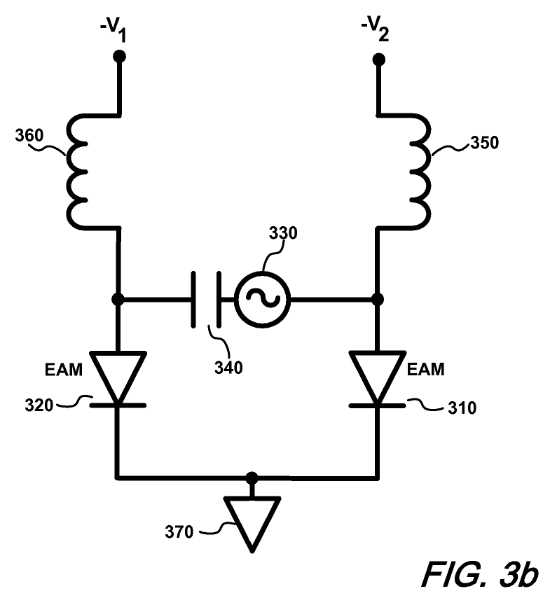

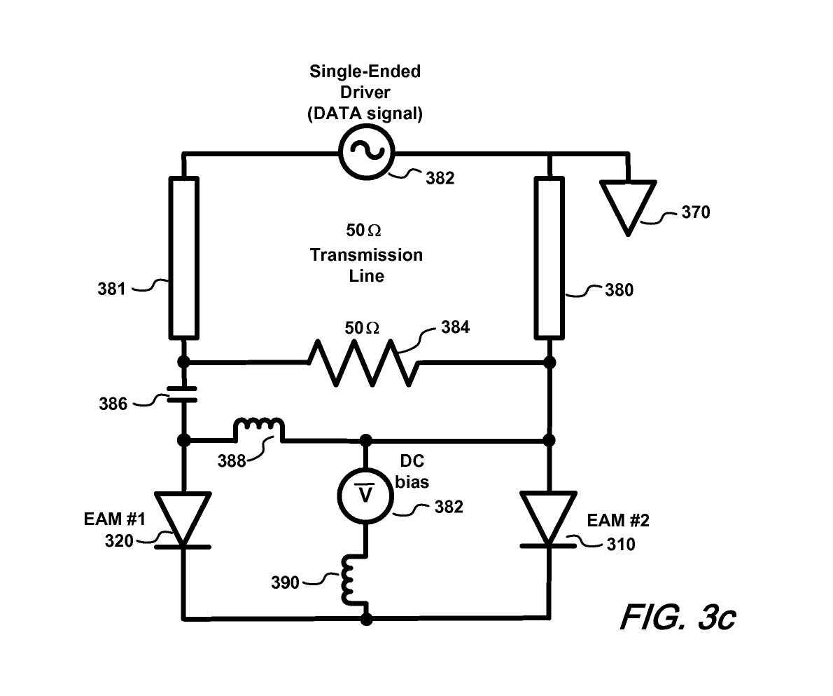

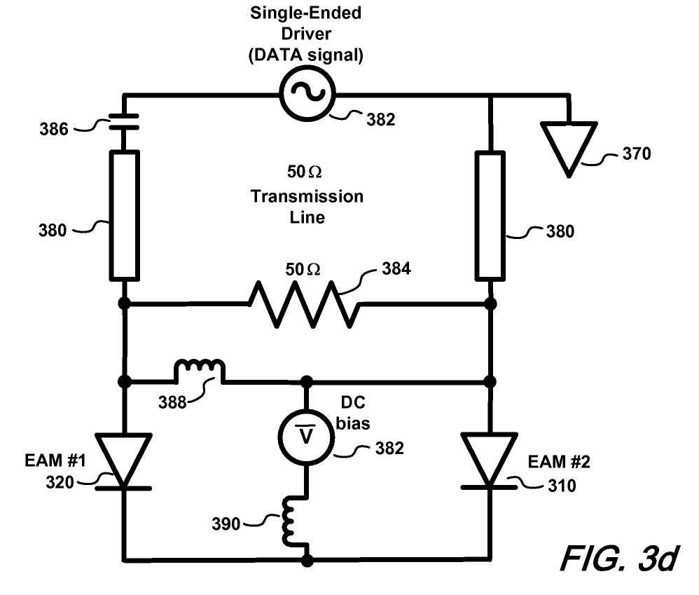

Turning now to FIG. 3a there is shown a schematic of a simplified drive circuit according to the present invention. As can be readily appreciated, the drive circuit shown in FIG. 3a may be used in conjunction with the Mach-Zehnder EAM modulator of FIG. 2a. As shown in FIG. 3a, the two EAMs 310, 320 are positioned in series with inductors 350, 360 respectively and common ground 370. DATA is applied to the EAMs 310, 320 in parallel while bias voltages −V₁ and −V₂ are maintained at the inductors 360, 350, respectively. Importantly, only a single DATA signal is required for this configuration. Advantageously, the orientation of the diodes may be flipped without affecting the spirit of the invention.

A bit more detail may be obtained with reference to FIG. 3b. In this embodiment, the DATA signal 330 is applied in parallel to the EAMs 320, 310, and DC blocking capacitor 340.

An alternative embodiment for a drive circuit according to the present invention is shown in FIG. 3c. As shown, a single-ended driver DATA signal 382 is applied in parallel to a pair of substantially 50 ohm transmission lines 380, 381 which are in series with EAMs 320, 310 respectively. The EAMs 320, 310 are biased through the effect of DC Bias voltage 382. As with the embodiment shown in FIG. 3b, the circuit shown in FIG. 3c permits the driving of the two EAMs 310, 320 with only a single DATA signal. Termination resistor 384 may be placed in a different location, such as below capacitor 386, or even be completely eliminated without affecting the spirit of the invention. Also, the transmission line may have a different impedance than 50 Ω.

Those skilled in the art will immediately appreciate that the drive circuits shown in FIG. 3b, FIG. 3c and FIG. 3d are directly applicable to the Mach-Zehnder EAM optical modulator of FIG. 2a which—if the one arm is biased by an amount substantially equal to 180°—will output DPSK signals. Duobinary output is also possible from this configuration if the electrical drive to the EAMs are low-pass filtered or the optical output is low-pass filtered. Alternatively, bandwidth limitations associated with the EAMs may provide the low-pass filtering.

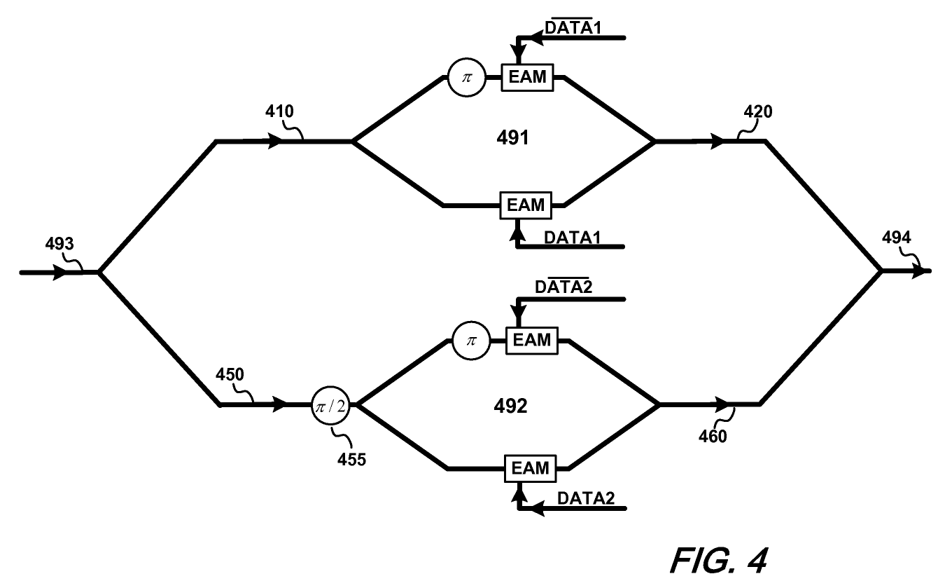

Advantageously, the Mach-Zehnder EAM modulator FIG. 2a may be used to construct a DQPSK modulator as shown in FIG. 4. In this DQPSK configuration, two Mach-Zehnder EAM modulators 491, 492 are configured in parallel such that they share a single input 493 and single output 494. When configured in this manner, an optical signal arriving at input 493 is split and the resulting signals are input to the individual Mach-Zehnder EAM modulators 491, 492 via inputs 410, 450 respectively. As shown in FIG. 4, one of the resulting split signals is phase shifted by an additional 90° through the effect of phase shifter 455. And while this phase shifter is shown as affecting the lower Mach-Zehnder EAM modulator 492, those skilled in the art will of course recognize that the phase shift could have been applied to the upper Mach-Zehnder EAM modulator 491 instead of the lower one.

Modulated signals are output from each of the Mach-Zehnder EAM modulators 491, 492 via outputs 420, 460 respectively and combined into a DQPSK signal which is provided at output 494. When configured in this manner, each of the individual Mach-Zehnder EAM modulators 491, 492 may be driven by an individual drive circuit such as that shown in FIG. 3b or FIG. 3c. As a result, each of the individual Mach-Zehnder EAM modulators 491, 492 may be driven by a single data signal.

At this point, while we have discussed and described our invention using some specific examples, those skilled in the art will recognize that our teachings are not so limited. In particular, while the single-ended driving circuit has been shown in certain particular configurations, those skilled in the art will readily appreciate that a number of the elements which are used to construct the drive circuits, i.e., resistors, capacitors, inductors, etc, may advantageously be rearranged to construct substantially equivalent circuits. Accordingly, our invention should be only limited by the scope of the claims attached hereto.

1. An optical modulator comprising:
a first Mach-Zehnder interferometer having an electro-absorption modulator (EAM) in each arm;
CHARACTERIZED IN THAT:
both EAMs are driven in a push-pull manner by only one, single ended-driver having only a single output, said single output having both a ground terminal and an active terminal where the ground terminal of the driver is connected to one EAM while the active terminal is connected to the other EAM,
such that each EAM generates an intensity modulated optical signal, and upon recombining the intensity modulated optical signals, the optical modulator generates a substantially chirp free signal having a modulation format that is one selected from a Phase Shift Key (PSK) and an on-off key (OOK).

2. The optical modulator of claim 1 further comprising;
a second Mach-Zehnder interferometer having an EAM in each arm, wherein said second Mach-Zehnder interferometer is configured in parallel with the first Mach-Zehnder interferometer resulting in a combined modulator;
FURTHER CHARACTERIZED IN THAT
both EAMs of the second Mach-Zehnder interferometer are driven in a push-pull manner by a second single-ended driver having both a ground terminal and an active terminal where the ground terminal of the second driver is connected to one EAM of the second Mach-Zehnder interferometer while the active terminal of the second driver is connected to the other EAM of the second Mach-Zehnder interferometer,
such that each EAM of the second Mach-Zehnder interferometer generates an intensity modulated optical signal, and upon recombining the intensity modulated optical signals, the second Mach-Zehnder interferometer generates a substantially chirp free signal having a modulation format that is one selected from a Phase Shift Keying (PSK) and an on-off keying (OOK).

3. The optical modulator of claim 1 further comprising a phase shifter positioned in one of the arms of the first Mach-Zehnder interferometer, wherein upon applying a relative phase shift substantially equal to 180°, the modulator generates the signal in a modulation format that is one selected from differential phase-shift keying (DPSK) and duobinary (DB).

4. The optical modulator of claim 2 further comprising a second phase shifter positioned in one of the arms of the second Mach-Zehnder interferometer and a third phase shifter positioned in one arm of the combined modulators,
such that upon applying a desired phase shift in the second phase shifter and a relative phase shift substantially equal to 90° in the third phase shifter, the combined modulator generates a signal in a differential quadrature phase-shift keying (DQPSK) modulation format.

5. (canceled)

6. (canceled)

7. A single-ended driver for an optical modulator, said modulator comprising:
a Mach-Zehnder interferometer having an electro-absorption modulator (EAM) in each arm;
said single-ended driver comprising:
a means for driving the EAMs in a complementary manner from a single DATA signal such that the each EAM generates an intensity modulated optical signal,
wherein said single-ended driver has only one output, said one output having one terminal that has a dynamic voltage and another terminal that has a grounded voltage.

8. The driver of claim 7 wherein said modulator further comprises:
a second Mach-Zehnder interferometer having an EAM in each arm, said second Mach-Zehnder interferometer being configured in parallel with the Mach-Zehnder interferometer resulting in a combined modulator; and
a second single-ended driver further comprising:
a second means for driving the EAMs in the second Mach-Zehnder interferometer in a complementary manner from a single DATA signal for generating intensity modulated optical signals.

9. The driver of claim 7 wherein upon application of an input optical signal and upon activating the driver the modulator produces an optical signal exhibiting a phase-shift keying (PSK) or on-off-keying (OOK) modulation format.

10. The optical modulator of claim 8 wherein upon application of an input optical signal and upon activating the first and second drivers the modulator produces an optical signal exhibiting a differential phase-shift keying or differential quadrature phase-shift keying modulation format.
